(19) United States
(12) Patent Application Publication
(10) Pub. No.: US 2020/0074276 A1
(43) Pub. Date: Mar. 5, 2020

(54) Providing Real-Time Predictive Feedback During Logic Design

(71) Applicant: International Business Machines Corporation, Armonk, NY (US)

(72) Inventors: Matthew Cooke, Cedar Park, TX (US); Brenton Yiu, Austin, TX (US); Ehsan Fatehi, Austin, TX (US); Ishan Jayesh Dalal, Worcester, MA (US)

(73) Assignee: International Business Machines Corporation, Armonk, NY (US)

(21) Appl. No.: 16/114,296

(22) Filed: Aug. 28, 2018

(51) Int. Cl. G06N 3/04; G06F 17/50; G06N 3/08

(52) U.S. Cl. CPC G06N 3/0427; G06F 17/505; G06F 2217/06; G06N 3/08; G06N 3/0454

(57) ABSTRACT

A system, computer program product, and method are provided to analyze logic design, and changes thereto. An intelligent real-time analytic system using machine learning features analyzes logic designs to determine estimated physical design statistics and generate predictions as to whether a design, or design features, can be physically implemented to meet all design constraints, or cause convergence issues. These predictions are generated in a fraction of the time it takes to generate a full physical design implementation. In addition, these predictions are physically conveyed to a designer as a manifestation of a physical implementation of a converged circuit design. The designer determines if the present design should be translated into a physical design construct and whether the associated data should be stored within the training database for use in subsequent designs.

### BACKGROUND

The present embodiment(s) relate to machine learning. More specifically, the embodiment(s) relate to an artificial intelligence platform to provide real-time feedback during logic design through predictively identifying potential design errors.

In the field of artificial intelligent computer systems, machine learning systems (such as the IBM Watson™ artificial intelligent computer system and other machine learning systems) are cognitive computing platforms that “learn” or are “trained” through accumulation of data. Machine learning, which is a subset of Artificial intelligence (AI), utilizes algorithms to learn from data and create foresights based on this data. AI refers to the intelligence when machines, based on information, are able to make decisions, which maximizes the chance of success in a given topic. More specifically, AI is able to learn from a data set to solve problems and provide relevant recommendations. AI is a subset of cognitive computing, which refers to systems that learn at scale, reason with purpose, and naturally interact with humans. Cognitive computing is a mixture of computer science and cognitive science. Cognitive computing utilizes self-teaching algorithms that use data minimum, visual recognition, and natural language processing to solve problems and optimize human processes.

Many electrical and electronic circuits and components such as Application-Specific Integrated Circuits (ASICs), Field-Programmable Gate Arrays (FPGAs), and System on Chip (SoC) circuits are designed through computer-aided design applications that facilitate creation, modification, analysis, and optimization of such circuits and components. In digital circuit design, register-transfer level (RTL) is often used to model a digital circuit in terms of the flow of digital signals (data) therein and logical operations performed on those signals. RTL is associated with hardware description languages (HDLs) such as Very High Speed Integrated Circuit (VHSIC) Hardware Description Analysis (VHDL) and Verilog to create high-level representations of a circuit, from which physical design implementation, from lower-level representations and ultimately to actual wiring, can be derived.

However, traditional design cycles require full physical implementation of the circuit design to obtain feedback for improvement to the logic designers. The physical design implementation time frames are often long and include synthesis, placement, routing, and timing analyses. Depending on the size of the project, these processes can take several hours to several days with multiple iterations to get an optimized design that meets timing, area, power, and other requirements. Once the analyses are completed, the results are used as feedback in the design process to identify areas of concern, and once the identified design changes are implemented, the feedback analyses are run iteratively until the circuit design is fully realized.

In addition, at the time of implementing the RTL changes to the design, it is difficult to predict the actual effect the changes will have on convergence, i.e., the iterative process of getting the circuit performance based on the physical layout results of the circuit to match those reported by logic synthesis, until full implementation. Many known methods of overcoming the extended design periods include tuning the initial planning efforts or the early implementation efforts. These known methods typically rely on some sort of back-annotation, i.e., improving an accuracy of circuit simulation through updating the logical design of the circuit with physically measured values, to facilitate feedback to the RTL designer.

### SUMMARY

The embodiments include a system, computer program product, and method for machine learning directed at providing real-time feedback during logic design though predictively identifying potential design errors.

In one aspect, a system is provided with a processing unit operatively coupled to memory, and a knowledge base operatively coupled to the processing unit. The knowledge base includes data associated with at least one circuit design constraint, such as power, timing, and area requirements. An artificial intelligence platform is provided in communication with the knowledge base. The AI platform includes tools therein to facilitate circuit analysis and designs. The tools include a design manager configured to receive register transfer level (RTL) design data from a hardware description language (HDL) design source. The design manager performs an RTL synthesis for the received RTL design data. The RTL synthesis returns a circuit design gate-level implementation including one or more critical metric data. The AI platform also includes a prediction manager in communication with the design manager. The prediction manager includes a machine learning block configured to receive the critical metric feature data generated from the RTL synthesis and the circuit design constraint from the knowledge base. The prediction manager is further configured to evaluate the critical metric data received from the design manager, which includes comparing the received critical metric data with the received circuit design constraint. The prediction manager further generates prediction data directed to performance of the received critical metric feature data based on the comparison. The design manager transmits the prediction data to a logic design source, where the prediction data includes physical design output statistics at least partially directed to convergence on a circuit design and physically convey a manifestation of a physical implementation of the converged circuit design to the logic design source.

In another aspect a computer program product is provided for electronic circuit design. The computer program product includes a computer readable storage device having program code embodied therewith that is executable by a processing unit. Program code is provided to store, in a knowledge base, at least one circuit design constraint. Program code is also provided to receive RTL design data from a hardware description level (HDL) design source. Program code is further provided to perform a register-transfer level (RTL) synthesis for the received RTL design data, including return a circuit design gate-level implementation including one or more critical metric feature data. Program code is also provided to evaluate the critical metric feature data, including comparison of the critical metric feature data with the circuit design constraint. Program code is further provided to generate prediction data directed at performance of the evaluated critical metric feature data based on the comparison of the critical metric feature data with the circuit design constraint. Program code is also provided to transmit the generated prediction data to a logic design source, the prediction data including a physical design output statistic at least partially directed to convergence on a circuit design, and conveying a manifestation of a physical implementation of the converged circuit design to the logic design source.

In yet another aspect, a method is provided for designing an electronic circuit. The method includes receiving RTL design data from a logic design source. A register-transfer-level (RTL) synthesis is performed for the received RTL design data and the RTL synthesis returns a circuit design gate-level implementation including one or more critical metric data. One or more critical metric feature data generated from the RTL synthesis and the circuit design constraint are received. The received critical metric feature data is evaluated, including comparison of the received critical metric feature data with the received circuit design constraint. The method further includes generating prediction data directed to performance of the received critical metric feature data based on the comparison. The prediction data is transmitted to a logic design source, where the prediction data includes physical design output statistics at least partially directed to convergence on a circuit design and physically conveying a manifestation of a physical implementation of the converged circuit design to the logic design source.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a schematic system diagram illustrating an artificial intelligence system.

FIG. 2 depicts a flow chart illustrating a high level process of incorporating a machine learning (ML) error prediction loop into electronic circuit design for a custom integrated circuit.

FIG. 3 depicts a flow chart illustrating a process for convergence failure prediction.

FIG. 4 depicts a flow chart illustrating a process for tracking product design changes.

FIG. 5 depicts a flow a flow diagram illustrating ML input and output process details.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

An intelligent system is provided with tools and algorithms to run intelligent real-time analytics using machine learning to analyze logic designs, and changes thereto. These systems are referred to as “cognitive compilers.” More specifically, the cognitive compiler is used to provide estimated physical design statistics and generate predictions as to whether a design, or design features, can be physically implemented to meet all design constraints, or at least the most important design constraints. The cognitive compiler generates predictions to finalize a particular circuit design through iterative evaluation. The predictions are generated through executing only the compile and synthesis steps prior to execution of subsequent steps, e.g., gate tuning, placement, routing, and timing steps. The physical implementation predictions generated by the system disclosed herein significantly decreases the elapsed time from initiation of the design analysis to delivery of feedback from hours and days to minutes, thereby increasing the productivity of the design process. The machine learning component, i.e., one or more machine learning blocks, of the system receives the products of the synthesis, i.e., the gate level netlist and gate level timing report, which include design requirements and design statistics, such prediction inputs (“critical metrics”) based on general, connectivity, and timing information for the global design and for specific worst-case paths/regions. In addition to binary pass/fall predictions, the machine learning component generates estimates that include area congestion, power, and timing estimates can be fed back to the designer with very short turn-around. These estimates are also useful in high-level design metrics over time.

In some embodiments, a machine learning block includes multiple learning templates that are selected based on global technology constraints and special-interest metrics from the netlist. Further, in some embodiments, a machine learning block includes different neural networks for different FPGA models or in the case of ICs, for different technologies. The neural networks are specifically trained as to design implementations that have been successful in meeting design constraints for physical implementation and other implementations that have historically not been successful. In addition to the neural networks, the machine learning block contains multiple instances of specific pattern detectors and global convergence predictors that leverage both global and design-specific inputs. Each of the specific pattern detectors is configured for a specific problematic RTL section, while the global convergence predictors take all factors into account to predict convergence. The best global detector for the task at hand is automatically selected based off the input design statistics, i.e., critical data. The global convergence predictors can be embedded in the main neural networks or can be separate, taking the predictions of the selected neural network as input features. The predictive output of the machine learning block includes a collection of tuples containing error type and an associated probability of the error occurring. This output data is converted into binary pass/fail criteria by hardcoded or user-defined thresholds. The design error data can be assigned to distinct design features.

Training of the machine block is performed on a regular basis as a stand-alone activity or as part of a regular software update. Data used for training the neural networks includes critical metrics, error messages, technology constraints, and user defined constraints. This data is used to calculate weightings for such training data, where the weightings are refined as the neural network is used and the relationships of the data to accuracy in predicting the outcome of design synthesis are further established. In one embodiment, a training database or data storage location is utilized to retain the training data. In some embodiments, networked cognitive compilers are distributed across multiple locations, where faster and broader learning is facilitated with global machine parameters updated across the network with training data from other designs and technologies. Accordingly, the associated tools, processes, machines, and algorithms described in detail below use the logic design data as input, with analysis and predictions thereof conducted by machine learning (ML).

The methods and processes described herein use input from a logic design source that includes, but is not limited to, a user, i.e., a human logic designer. Prediction outputs from the system are subject to evaluation by the designer to determine if the present design features meet required design constraints with respect to circuit convergence (closure). Subsequent runs through the process with the design features selected and/or modified by the designer will have a unique identifier to facilitate tracking various iterations through the design process. Once the designer determines that the manifestation of a converged physical design is physically conveyed thereto, the designer performs one or more further evaluations of the converged physical design. The evaluation includes determining if the present design should be translated into a physical design construct and whether the associated data to indicate that the data associated with a particular design is flagged for pushing the data into the training database for storage and future use in subsequent designs.

In the circumstances where no previous runs through the process exist for a particular technology, circuit type, circuit design, or specific circuit features, the system may be networked as described herein to similar systems physically located throughout an established network, e.g., a world-wide network. The system associated with the logic design source can use data located in other locations to facilitate a first run of a unique circuit design through this particular system to initiate establishment of circuit design and learning data (including convergence predictions and critical metric data) particular to this circuit design. Existing design data may be selectively utilized where, for example, a new RTL was released before a reasonable physical design was established. The user may also optionally use a block-offset that is embedded in the design metrics. In such cases, a designer-selected offset may be used to offset known or suspected errors in the predicted values and error probabilities to gain more accurate predictions when a new design is being implemented and the available training data library is relatively small. The data generated by the system described herein may be stored in the associated training database residing in the knowledge base, or otherwise stored in an alternative library by the user to facilitate tracking accuracy and design specific offsets as more data is added to the training database.

The following detailed description is directed at a system and associated flow charts to illustrate functionality of the product design and creation. The aspects discussed are directed to electronic circuit design for an integrated circuit (IC) and field programmable gate arrays (FPGAs). In one embodiment, the aspects may be extended to product design and creation of electronic circuit design for various substrates, and as such should not be considered limiting.

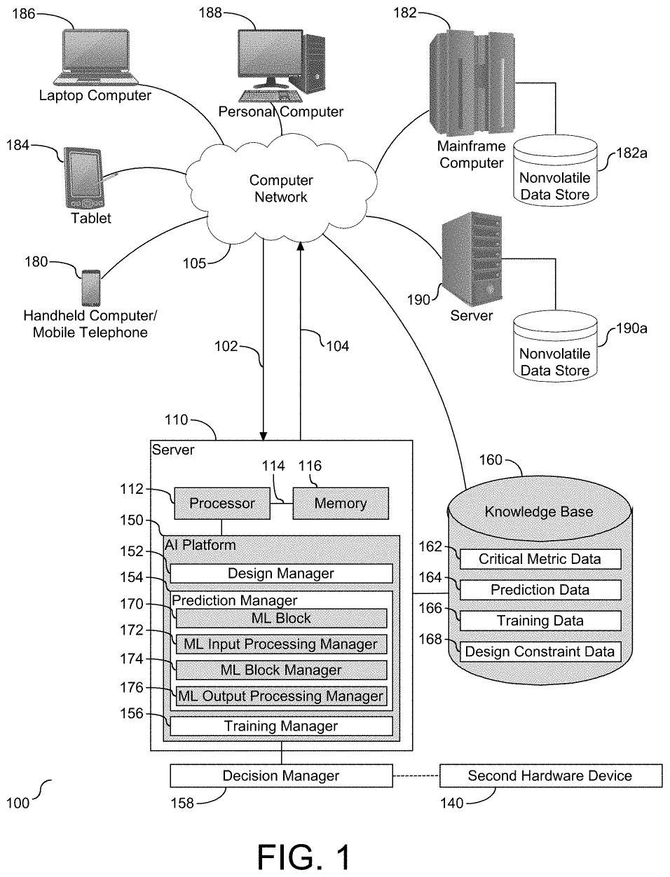

Referring to FIG. 1, a schematic diagram of an artificial intelligence system (100), e.g. a system for analyzing logic design, is depicted. As shown, a server (110) is provided in communication with a plurality of computing devices (180), (182), (184), (186), (188), and (190) across a network connection. The computer network may include several devices. Types of information handling system that can utilize system (110) range from small handheld devices, such as a handheld computer/mobile telephone (180) to large mainframe systems, such as a mainframe computer (182). Examples of information handling systems includes, personal digital assistants (PDAs), personal entertainment devices, pen or tablet computer (184), laptop or notebook computer (186), personal computer system (188), and server (190). As shown, the various information handling systems can be networked together using computer network (105).

The computing devices (180), (182), (184), (186), (188), and (190) communicate with each other and with other devices or components via one or more wires and/or wireless data communication links, where each communication link may comprise one or more of wires, routers, switches, transmitters, receivers, or the like. In this networked arrangement, the server (110) and the network connection (105) may enable and support artificial intelligence and machine learning. Other embodiments of the server (110) may be used with components, systems, sub-systems, and/or devices other than those depicted herein.

Various types of a computer network (105) can be used to interconnect the various information handling systems, including Local Area Networks (LANs), Wireless Local Area Networks (WLANs), the Internet, the Public Switched Telephone Network (PSTN), other wireless networks, and any other network topology that can be used to interconnect information handling systems and computing devices. Many of the information handling systems include non-volatile data stores, such as hard drives and/or non-volatile memory. Some of the information handling systems may use separate non-volatile data stores (e.g., server (190) utilizes non-volatile data store (190a), and mainframe computer (182) utilizes non-volatile data store (182a)). The non-volatile data store (182a) can be a component that is external to the various information handling systems or can be internal to one of the information handling systems.

The server (110) is configured with a processing unit (112) operatively coupled to memory (116) across a bus (114). An artificial intelligence (AI) platform (150) is shown embedded in the server (110) and in communication with the processing unit (112). In one embodiment, the AI platform (150) may be local to memory (116). The AI platform (150) provides support for electronic circuit design using machine learning (ML) to evaluate design aspects and functionality in real-time together with physical implementation for design aspects meeting or exceeding constraints. As shown, the AI platform (150) includes tools which may be, but are not limited to, a design manager (152), a prediction manager (154), and a training manager (156). Each of these tools functions separately or combined in the AI platform (150) to dynamically evaluate logic design data and associated characteristics and determine and/or initiate a course of action based on the analysis. The prediction manager (154) supports machine learning (ML) functionality and includes tools to support ML, including an ML Input Processing Manager (172), an ML Block Manager (174), and an ML Output Processing Manager (176). Accordingly, the AI platform (150) provides interaction analysis over the network (105) from one or more computing devices (180), (182), (184), (186), (188), and (190).

As further shown, a knowledge base (160) is provided local to the server (110), and operatively coupled to the processing unit (112) and/or memory (116). In one embodiment, the knowledge base (160) may be in the form of a database. In one embodiment, the knowledge base (160) may be operatively coupled to the server (110) across the network connection (105). The knowledge base (160) includes different classes of data, including, but not limited to, critical metric data (162), prediction data (164), and training data (166).

The AI platform (150) and the associated tools (152)-(156) leverage the library in design evaluation and implementation. The design manager (152) is configured to receive design feature data from a logic design source (not shown) and to process the received data. It is understood that a register-transfer-level (RTL) change may cause convergence issues. Area, power, timing, routing, EM/IR, and other physical implementation constraint implications of the RTL change(s) are not obvious or apparent until full implementation. The design manager (152) is configured to perform register-transfer-level (RTL) compilation and synthesis directed at the received design feature data. The RTL synthesis returns a circuit design implementation that includes and/or identifies one or more critical metric data (162). In one embodiment, gate level netlist data and the gate level timing report translates to the critical metric data (162) that defines global statistics. Similarly in one embodiment, the gate level netlist and the gate level timing report are generated as a product of the RTL synthesis by the design manager (152). The prediction manager (154), which is operatively coupled to the design manager (152), is configured to feed critical metric data into a machine learning block (170), comprised of then ML Input Processing Manager (172), the ML Block Manager (174), and the ML Output Processing Manager (176).

As shown, the machine learning block (170) receives critical metric data from the RTL synthesis. In one embodiment, the critical metric data (162) is communicated or received from the knowledge base (160). It is understood that different substrates and associated components have design and technology constraints, which are shown herein as design constraint data (168) local to the knowledge base (160). Examples of the constraint data (168) include, but are not limited to, FPGA part information, die area, frequency, power requirements, available library elements, and technology details. With the critical metric data (162) and the constraint data (168), the ML block (170) conducts an evaluation in the form of a comparison of the critical metric data (162) with the constraint data (168). Based on the evaluation, the ML block (170) generates prediction data (164) directed at performance of the critical metric data (162) in view of the evaluation. Performance of the critical metric data can imply a timing component, or in one embodiment may imply power, area, EM/IR and other physical aspects which have constraints to be met. In one embodiment, the ML block (170) is taking in multiple input features and evaluating multiple constraints in parallel. Similarly, in one embodiment, the ML block (170) outputs a collection of tuples containing error type and probability of the error occurring. The output is converted into pass/fail criteria by hard coded or user defined thresholds. In one embodiment, the ML block (170) comprises a plurality of neural networks trained to analyze circuit design for a predetermined technology, including but not limited to, application specific integrated circuits (ASICs), field programmable gate arrays (FPGAs), and system on chip circuits (SoCs). Accordingly, the ML block (170) performs evaluation across multiple data points in parallel.

Once the ML block (170) generates an error list and has error values assigned to each error, this information can be used to highlight specific sections of the RTL netlist that may be the cause of the problem, e.g. error. Incremental compile data can be used to identify the changes that caused these errors to arise or increase in probability. With real-time reporting or highlighting, a unique compile identifier and incremental compile data may be generated to track each compilation iteration. In one embodiment, changes can be made directly in the netlist by implementing ECOs, wherein spare cells and rewiring can be used to correct any bugs directly in the synthesized netlist, thereby eliminating a complete iteration of the implementation process during iterative design developments.

The design manager (152) is shown operatively coupled to the prediction manager (154). The design manager (152) transmits the prediction data (164) to a logic design source (not shown). The prediction data (164) includes physical design output statistics, which is at least partially directed to convergence on a circuit design. In one embodiment, the logic design source is a physical machine that implements creation and/or manufacture of the circuit design.

The AI platform (150) supports convergence on the circuit design in real-time. The AI platform (150) is shown with a training manager (156) to train the ML Block (170), and more specifically to update the ML block (170) with circuit design constraints. The training manager (156) employs associated training data (164), such as critical metric data, error messages, technology constraints, and user-defined constraints, to calculate weights. As the knowledge base (160) expands with additional data, the weights may be refined. In one embodiment, critical metrics are saved along with a unique RTL identifier in the training data (164) to be matched with convergence data by the training manager (156) from actual implementation runs in order to generate training data sets. In one embodiment, the weightings on the critical metrics are dynamic, e.g. subject to change, as the ML block (170) makes predictions and is subject to periodic training. For example, in one embodiment, metrics that are more useful or accurate in predicting the outcome of design synthesis will be subject to more weighting. In one embodiment, the ML block (170) utilizes detectors, such as a pattern detector and a global convergence detector, that are at least partially based on training data received from the training manager (156). In some embodiments, specific pattern detectors are used for specific problematic RTL sections of the circuit design. Also, in some embodiments, the global convergence detector uses a greater number of factors than the specific pattern detectors to predict convergence of a design.

The various computing devices (180), (182), (184), (186), (188), and (190) in communication with the network (105) demonstrate access points to the AI platform (150) and the associated knowledge base (160). Some of the computing devices (180), (182), (184), (186), (188), and (190) may include devices for a database storing at least a portion of the library (162) stored in knowledge base (160). The network (105) may include local network connections and remote connections in various embodiments, such that the knowledge base (160) and the AI platform (150) may operate in environments of any size, including local and global, e.g., the Internet. Additionally, the server (110) and the knowledge base (160) serve as a front-end system that can make available a variety of knowledge extracted from or represented in documents, network accessible sources, and/or structured data sources.

The server (110) may be the IBM Watson™ system available from International Business Machines Corporation of Armonk, N.Y., which is augmented with the mechanisms of the illustrative embodiments described hereafter. The IBM Watson™ knowledge manager system imports knowledge into natural language processing (NLP). Specifically, as described in detail below, as dialogue data is received, organized, and/or stored, the data will be analyzed to determine the tone of the underlying data within the dialogue and assign an appropriate rating to the dialogue, e.g., interaction. The server (110) alone cannot analyze the data and determine an appropriate rating for the interaction due to the nuances of human conversation, e.g., inflections, volume, use of certain terms, including slang, and the like. As shown herein, the server (110) receives input content (102), which it then evaluates to determine implementation of the converged circuit design. In particular, received content (102) may be processed by the IBM Watson™ server (110) which performs analysis to evaluate the RTL Netlist.

The system shown and described herein further includes a decision manager (158). In one embodiment, the decision manager (158) is a hardware device operatively coupled to the server (110) and in communication with the AI platform (150) and the associated tools. The decision manager (158) is also operatively coupled to the processing unit (112) and receives instruction output from the processing unit (112) associated with the RTL evaluation. Receipt of the instruction from the processing unit (112) causes a physical action associated with the decision manager (158). Examples of the physical action include, but are not limited to, a state change of the decision manager (158), actuation of the decision manager (158), and maintaining an operating state of the decision manager (158).

The decision manager (158) facilitates implementation of the converged circuit design. Upon determination by the design manager (152) that a particular design configuration is to be implemented, a processing instruction is transmitted from the processing unit (112) to the decision manager (158), which undergoes a change of state upon receipt of the associated instruction. In one embodiment, the design manager generates a flag or instructs the processing unit (112) to generate the flag, with the flag directly corresponding to a state of the decision manager (158). More specifically, the decision manager (158) may change operating states in response to receipt of the flag and based upon the characteristics or settings reflected in the flag. The change of state includes the decision manager (158) changing states, such as shifting from a first state to a second state. In one embodiment, the first state is a reviewing state, also referred to herein as an inactive state, and the second state is an active state.

It is understood that actuation of the decision manager (158) actuating a second hardware device (140). In one embodiment, the second hardware device (140) is a physical hardware device responsible for executing and implemented an associated product design, e.g. manufacture and assembly of the product design. The described example actuation of the decision manager (158) and the second hardware device (140) should be viewed as a non-limiting example of such actuations. Once the product design and manufacture has been instruction or in one embodiment is completed, the decision manger (158) and the second hardware device (140) will be commanded to return to the prior states of operation.

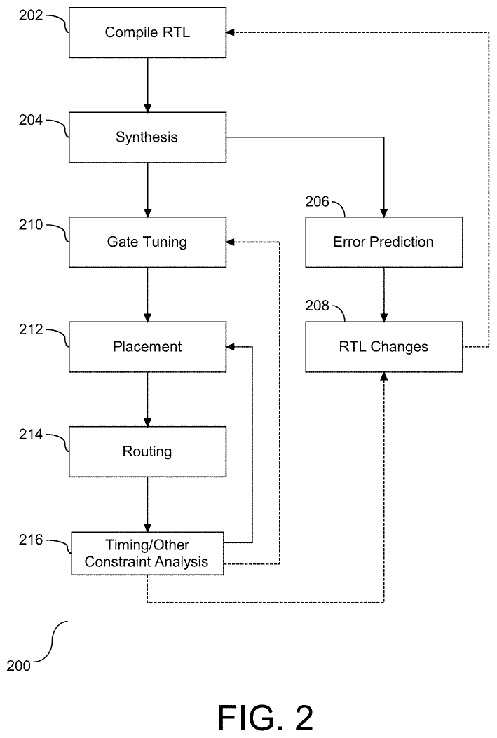

Referring to FIG. 2, a flow chart (200) is provided illustrating a high level process of incorporating a machine learning (ML) error prediction loop into electronic circuit design for a custom integrated circuit. As shown, the process is initiated with a register-transfer-level (RTL) compilation (202), followed by a synthesis for the RTL compilation (204). Following step (204), the circuit design process follows two paths in parallel. One path employs a machine learning (ML) error prediction loop after the synthesis at step (204). This loop employs training data from different designs to perform real-time error prediction (206), output any identified RTL changes (208), which are then input into the compilation at step (202). Another path is directed at gate tuning (210), placement (212), routing (214), and analysis of timing, power, noise, EM/IR, and other constraints (216), followed by a return to step (208) for any identified RTL changes. It is understood that the analysis may be followed by subsequent physical placement changes and associated design construction as needed to meet constraints. In one embodiment, the physical placement and associated design constructions are stored in a training corpus. The compilation and synthesis steps (202) and (204) are directed at ASIC, FPGA, and SoC design. It is noted that the compilation and synthesis at steps (202) and (204) take a fraction of the time to complete compared to placement, routing, and timing analysis, at steps (212)-(216), respectively. Accordingly, the ML loop shown at steps (208) and (210) are directed at error prediction and convergence analysis proximal to compilation and synthesis.

The process steps shown in FIG. 2 may be similarly utilized for design of a field programmable gate array (FPGA). The differences would be directed to steps (210)-(214) with the gate tuning replaced by synthesis optimization, the placement replaced with mapping of state points, and the routing replaced with mapping of logic blocks and look-up tables (LUTs). Accordingly, the design process steps shown and described in FIG. 2 should not be limited to an integrated circuit.

A critical piece to getting accurate predictions is converting a gate level netlist to a list of critical metrics that define global statistics. Critical metrics are normalized and used as input features for the machine learning block. These can fall into several categories, including global metrics, e.g. overall statistics about design, synthesis timing metrics, e.g. metrics related to information from one or more synthesis timing reports, and connectivity and complexity metrics, e.g. metrics related to connectivity information from a synthesized netlist. Orthogonal to these categories, some metrics will be specific to timing paths or connectivity regions that are most likely to have difficulties routing or meeting timing. Such metrics include, but are not limited to, metrics on specific worst timing paths, e.g. X timing paths, and metrics on specific connected regions. Metrics can be overlapping combinations of the above-categories. Some metrics also contain elements of timing metrics and connectivity metrics, whether they are for a specific connected region or a specific timing path. Similarly, metrics may also be directed at power based metrics and estimated EM based metrics.

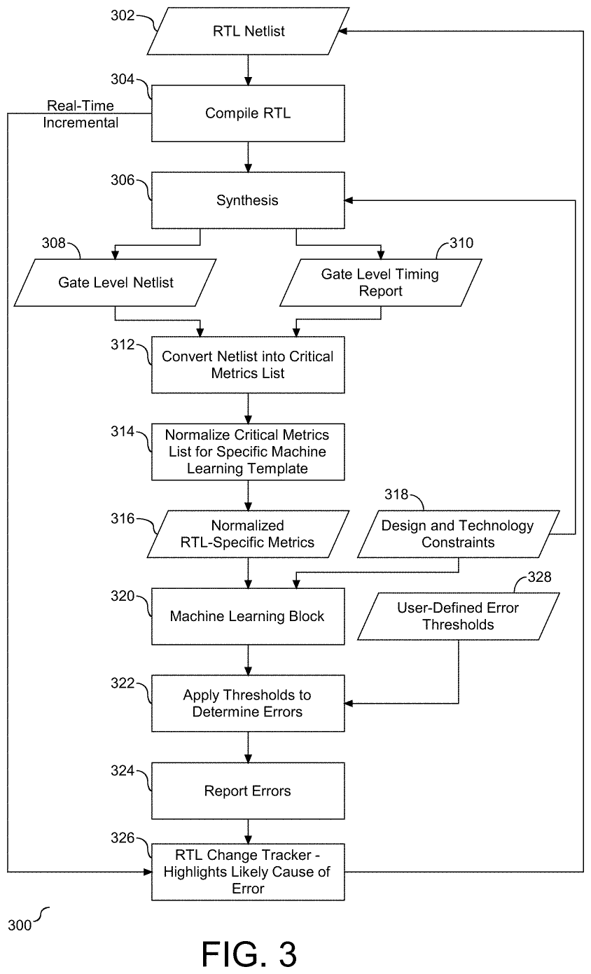

Referring to FIG. 3, a flow chart (300) is provided illustrating a process for convergence failure prediction. As shown, an RTL Netlist is provided and subject to editing (302). As shown and described in FIG. 2, the RTL is compiled (304) and synthesized (306). As shown and described herein, the RTL compilation takes place in real-time. The RTL synthesis generates a Gate Level Netlist (308) and a Gate Level Timing Report (310), shown herein as being generated in parallel. In one embodiment, the Gate Level Netlist (308) and the Gate Level Timing Report (310) are created sequentially. Following steps (308) and (310), the ML loop shown in FIG. 2 is employed to evaluate for error prediction. Accordingly, steps (302)-(308) are directed to preliminary processing for the ML loop.

Details of the ML loop are shown and described in step (312)-(320). As shown, the ML loop extracts data from the Netlist and converts the extracted data into a critical metrics list (312), e.g. converts the Netlist into a format for ML processing. Thereafter, the critical metrics list for a specific ML template is normalized (314), followed by normalizing RTL specific metrics (316). The normalized features from steps (314) and (316) are values that can be fed into the machine learning block (320), e.g. neural network. Some of these values will be in terms of percent or decimal values in a predefined range. For example, in one embodiment, “the number” or “count” metrics would be divided by a total number of that type of object in the design or total of that object in a specific context. In addition, design and technology constraints (318) and associated values are also fed into the machine learning block (320). These constraints are also used in the synthesis step (306), where the constraints facilitate generation of the critical metrics. Examples of the design and technology constraints include, but are not limited to, FPGA part information, die area, frequency, power requirements, available library elements, and technology details. In one embodiment, the constraints at step (318) are referred to as global design technology features. Similarly, in one embodiment, the constraints at step (318) are provided or available in the knowledge base (160).

Inside the machine learning block (320) there are multiple learning templates that are selected based on global technology constraints and special-interest metrics from the Netlist. In on embodiment, it is advantageous to have different neural networks for different FPGA models or in the case of ICs, for different technologies. Further differentiation can come from global constraints or specific critical metrics. In one embodiment, the machine learning block (320) may employ local design-specific or user-specific pattern detectors that may be neural networks, logic block identifier comparators, or a combination of both. The local networks can track and learn from specific design patterns or track logic that specific design problems. Output from the machine learning block (320) is in the form of a collection of tuples containing error type and probability of error occurring. As shown, one or more thresholds are applied to the ML output to determine presence of errors (322). In one embodiment, the output from the machine learning block is converted into pass/fail criteria by hardcoded or user-defined thresholds (328). Once the ML block generates an error list and has error values assigned to each error (324), this information is forwarded to an RTL change tracker (326) and can be used to highlight specific sections of the RTL netlist that may be the source of the problem. Accordingly, as shown, the ML block functions as a dynamic feedback mechanism using machine learning utilizing normalized metric lists related to netlists of design.

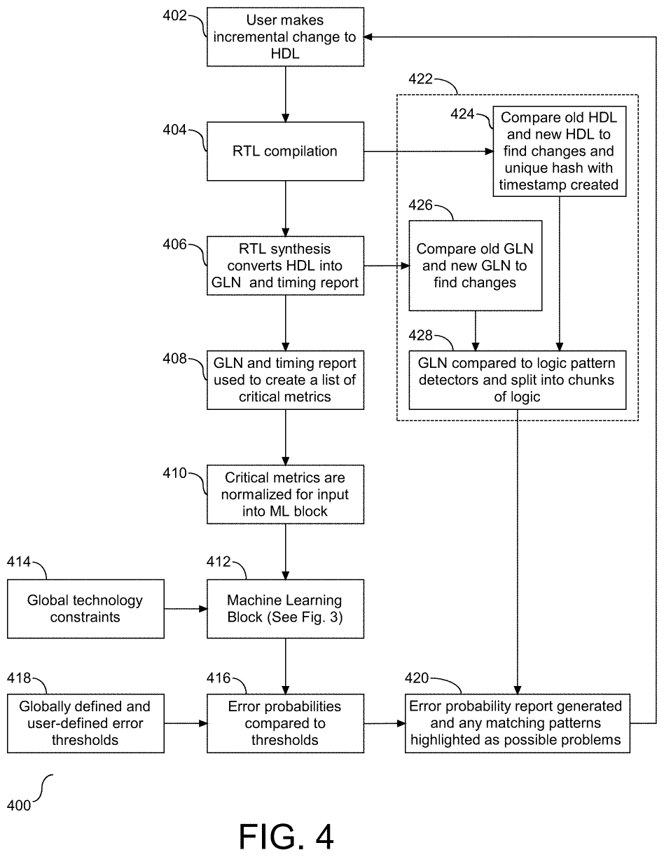

Referring to FIG. 4, a flow chart (400) is provided illustrating tracking product design changes. As shown, one or more incremental changes are made to the product design (402). In one embodiment, the changes are reflected in associated hardware description language (HDL). Following step (402), RTL compilation and RTL synthesis takes place (404) and (406), e.g. see steps (304) and (306). The RTL synthesis at step (406) converts the HDL into a gate level netlist (GLN) and timing report. A list of critical metrics is created from the GLN and the timing report (408). Thereafter, the critical metrics are normalized to features for input into the ML block (410). As shown and described in FIG. 3, the ML block (412) receives the normalized data from step (410) and the global technology constraints from an operatively connected knowledge base (414), The ML block processes the data and generates output directed at error probabilities (416). Thresholds, including globally defined thresholds and/or user defined thresholds (418) are applied to the error probabilities, and an error probability report is generated, including identification of any matching patterns that may highlight a source of error (420).

As shown, the error probability report receives input from the ML block and application of one or more thresholds to associated data. In addition, further data is created with respect to the RTL compilation and the RTL synthesis. Following the RTL compilation at step (404), the HDL is evaluation to identify any compilation changes (424). In one embodiment, the HDL evaluation includes comparing two HDL versions, identification of changes, creating a unique hash to the changes, and assigning a time stamp top the hash. Following the RTL synthesis at step (406), any changes to the GLN are identified (426). In one embodiment, the identification at step (426) includes comparison of two GLNs. Output of the identified changes from steps (424) and (426) are employed as input to compare the GLN to logic pattern detectors and split into chunks of logic (428). In one embodiment, the assessment at steps (424)-(428) take place in real-time. Similarly, in one embodiment, the assessment at steps (424)-(428) is conducted by the design manager (422). The chunks of logic generated at step (428) are received as input into the ML block (420) for error evaluation and reporting. Accordingly, as shown herein, changes to the GLN and the HDL are tracked, identified, and applied to the ML block in real-time for error identification and evaluation.

As shown and described, the ML block takes normalized features and predicts convergence of constraints. Out of probability of convergence is directed to area, power, and timing, and in one embodiment, specific values for each. The error report generated at step (420) includes a list of errors and one or more values assigned to each error. This information can be used to highlight specific section of the RTL netlist that may be the cause of the error, e.g. problem. Incremental data identified at steps (424) and (426), may be used to identify the changes that caused the errors to arise or increase in probability. In one embodiment, a compile identifier is assigned to incremental compilation data to track iterations. Accordingly, the identifiers are utilized to identify different iterative RTL compile/synthesis cycles and the associated critical metrics and prediction outputs.

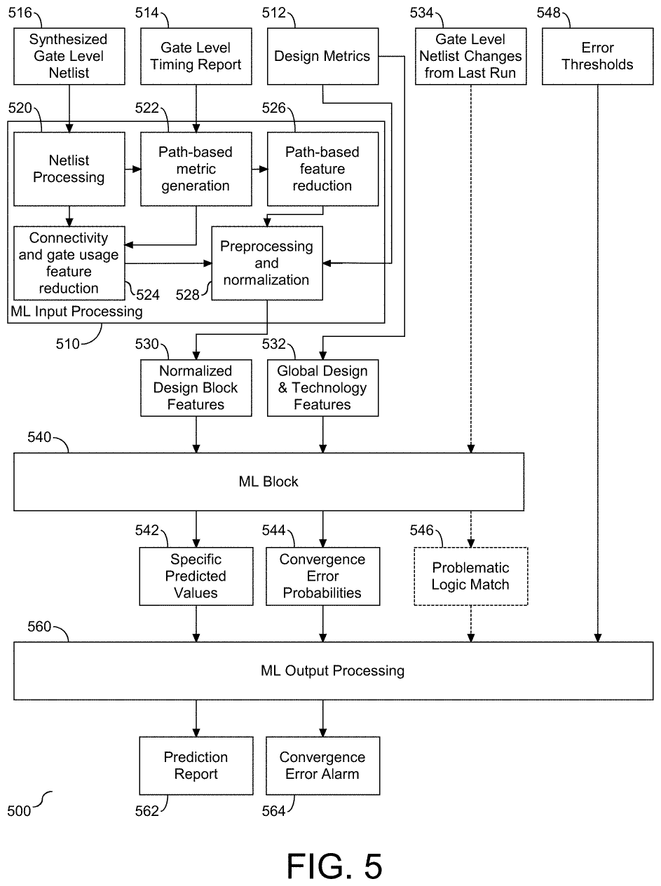

As shown and described, the ML block predicts whether a design can be physically implemented to meet all or a selection of design constraints. The real-time assessment and evaluation is limited to RTL compilation and synthesis, thereby reducing an associated feedback loop for RTL compliance. In one embodiment, the feedback is referred to as delayed iterative feedback as one or more sections of RTL are changed. The ML block is operatively coupled to the knowledge base (160), which includes a corpus of RTL configurations, to evaluate associated constraints. Referring to FIG. 5, a flow diagram (500) is provided illustrating ML input and output process details. As shown, the ML processing includes ML Input Processing (510), an ML Block (540), and ML Output Processing (560). The ML Input Processing (510) includes three input elements, including design metrics (512), gate level timing report(s) (514), and synthesized gate level netlist(s) (GLNs) (516). From the GLN(s), the ML Input Processing (510) processes the netlist(s) (520), and together with the gate level timing report(s) (514) generates a path-based metric (522) and connectivity and gate usage feature reduction (524) and a path-based feature reduction (526). With the design metric input (512), the path-based feature reduction (526), and the gate usage feature reduction (524), the ML Input Processing (510) conducts pre-processing and normalization (528). Output from the ML Input Processing (510) is in the form of normalized design block features (530).

The ML block (540) receives input from the ML Input processing (510) in the form of the normalized design block features (530) and global design and technology features (532) received from the design metrics (512). In one embodiment, the ML Block (540) also receives input in the form of gate level netlist (GLN) changes from a prior run (534), e.g. iteration. The ML Block (540) generates output in the form of specific predicted values (542) and convergence error probabilities (544). Details of the processing and output creation are shown and described in FIGS. 2-4. In one embodiment, the ML Block (540) also generates output in the form of problematic logic match (546) as it corresponds to the gate level netlist (GLN) changes from the prior run at (534). The predicted value and convergence error output (542) and (544), respectively, are received as input to the ML Output Processing (560). In addition, error thresholds (548) are also employed as input to the ML Output Processing (560). Two forms of output data are generated at (560), including a prediction report (562) and convergence error alarm (564). In one embodiment, the output data (562) and (564) are utilized to track and create changes to the RTL design and placement.

As shown and described, ML is employed in the design and configuration of a substrate and associated components, with the ML predicting viability of an associated physical implementation to meet all design constraints. The evaluation and implementation processing takes place in real-time and requires only compiling RTL and synthesis.

The system and flow charts shown herein may also be in the form of a computer program device for use with an intelligent computer platform. The device has program code embodied therewith. The program code is executable by a processing unit to support the described functionality, and specifically providing real-time predictive feedback during logic design.

While particular embodiments have been shown and described, it will be obvious to those skilled in the art that, based upon the teachings herein, changes and modifications may be made without departing from the embodiment and its broader aspects. Therefore, the appended claims are to encompass within their scope all such changes and modifications as are within the true spirit and scope of the embodiment. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiment(s) may be a system, a method, and/or a computer program product. In addition, selected aspects of the present embodiment(s) may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiment(s) may take the form of computer program product embodied in a computer readable storage medium (or media) having computer readable program instructions thereon for causing a processor to carry out aspects of the present embodiment(s). Thus embodied, the disclosed system, a method, and/or a computer program product are operative to improve the functionality and operation of a machine learning model based on veracity values and leveraging BC technology.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments on may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, the RTL synthesis and evaluation may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A system comprising:
a processing unit operatively coupled to memory;
a knowledge base operatively coupled to the processing unit, the knowledge base including data associated with at least one circuit design constraint; and
an artificial intelligence (AI) platform, in communication with the knowledge base, the AI platform comprising:
a design manager to:
receive register transfer level (RTL) design feature data from a hardware description level (HDL) design source; and
perform an RTL synthesis for the received RTL design data, the RTL synthesis to return a circuit design gate-level implementation comprising one or more critical metric feature data; and
a prediction manager in communication with the design manager, the prediction manager comprising a machine learning block to:
receive the one or more critical metric feature data generated from the RTL synthesis;
receive the circuit design constraint from the knowledge base;
evaluate the critical metric data received from the design manager, including compare the received critical metric data with the received circuit design constraint; and
generate prediction data directed to performance of the received critical metric data based on the comparison; and
the design manager to transmit the prediction data to a logic design source, wherein the prediction data comprises physical design output statistics at least partially directed to convergence on a circuit design and physically convey a manifestation of a physical implementation of the converged circuit design to the logic design source.

2. The system of claim 1, further comprising a training manager in communication with the prediction manager, the training manager to train the machine learning block, including update the machine learning block with the circuit design constraint.

3. The system of claim 1, further comprising the training manager to update the knowledge base with the prediction data and the critical metrics.

4. The system of claim 1, wherein the critical metrics are at least partially based on a gate level netlist and a gate level timing report.

5. The system of claim 4, wherein the gate level netlist and the gate level timing report are generated as a product of the RTL synthesis.

6. The system of claim 1, wherein the machine learning block comprises a plurality of pattern detectors and global convergence detectors at least partially based on training data received from the training manager.

7. The system of claim 1, wherein each set of critical metrics data and each prediction is associated with a particular design change and includes a unique RTL identifier.

8. The system of claim 1, wherein the machine learning block comprises a plurality of neural networks, wherein each neural network is trained to analyze circuit design for a predetermined technology, selected from the group consisting of: an Application-Specific Integrated Circuit (ASIC), a Field-Programmable Gate Array (FPGA), and System on Chip (SoC) circuit.

9. A computer program product for electronic circuit design, the computer program product comprising a computer readable storage device having program code embodied therewith, the program code executable by a processing unit to:
store, in a knowledge base, at least one circuit design constraint;
receive register transfer level (RTL) design data from a hardware description level (HDL) design source, and perform an RTL synthesis for the received RTL design data, including return a circuit design gate-level implementation comprising one or more critical metric feature data;
evaluate the critical metric data, including compare the critical metric feature data with the circuit design constraint;
generate prediction data directed at performance of the evaluated critical metric data based on the comparison of the critical metric data with the circuit design constraint; and
transmit the generated prediction data to a logic design source, the prediction data including a physical design output statistic at least partially directed to convergence on a circuit design, and physically conveying a manifestation of a physical implementation of the converged circuit design to the logic design source.

10. The computer program product of claim 9, further comprising program code to update the knowledge based with the prediction data and one or more critical metrics.

11. The computer program product of claim 9, wherein the critical metrics are at least partially based on a gate level netlist and a gate level timing report.

12. The computer program product of claim 11, wherein the gate level netlist and the gate level timing report are generated as a product of the RTL synthesis.

13. The computer program product of claim 9, wherein each set of critical metrics data and each prediction is associated with a particular design change and includes a unique RTL identifier.

14. The computer program product of claim 9, further comprising neural network program code, wherein each neural network is trained to analyze circuit design for a predetermined technology, the analyzed circuit design selected from the group consisting of: an Application-Specific Integrated Circuit (ASIC), a Field-Programmable Gate Array (FPGA), and System on Chip (SoC) circuit.

15. A method for designing an electronic circuit, comprising:
receiving register transfer level (RTL) design feature data from a hardware description level (HDL) design source;
performing an RTL synthesis for the RTL design feature data, the RTL synthesis returning a circuit design gate-level implementation comprising one or more critical metric feature data;
receiving the one or more critical metric feature data generated from the RTL synthesis;
receiving the circuit design constraint from the knowledge base;
evaluating the received critical metric data, including comparing the received critical metric data with the received circuit design constraint;
generating prediction data directed to performance of the received critical metric data based on the comparison; and
transmitting the prediction data to a logic design source, wherein the prediction data comprises physical design output statistics at least partially directed to convergence on a circuit design; and physically conveying a manifestation of a physical implementation of the converged circuit design to the logic design source.

16. The method of claim 15, further comprising updating the knowledge base with the prediction data and the critical metrics.

17. The method of claim 15, wherein the critical metrics are at least partially based on a gate level netlist and a gate level timing report.

18. The method of claim 17, wherein the gate level netlist and the gate level timing report are generated as a product of the RTL synthesis.

19. The method of claim 15, wherein each set of critical metrics data and each prediction is associated with a particular design change and includes a unique RTL identifier.

20. The method of claim 15, wherein a neural network generates the prediction data through analyzing the circuit design for a predetermined technology, the analyzed circuit design selected from the group consisting of: an Application-Specific Integrated Circuit (ASIC), a Field-Programmable Gate Array (FPGA), and System on Chip (SoC) circuit.
